(19) United States
(12) Patent Application Publication
(10) Pub. No.: US 2014/0316832 A1
(43) Pub. Date: Oct. 23, 2014

(54) Recruiting Management System

(71) Applicants: Sean Patrick Devlin, Lambertville, NJ (US); Bradlee Downs, Allentown, NJ (US)

(72) Inventors: Sean Patrick Devlin, Lambertville, NJ (US); Bradlee Downs, Allentown, NJ (US)

(73) Assignee: Front Rush, LLC., Lambertville, NJ (US)

(21) Appl. No.: 13/915,152

(22) Filed: Jun. 11, 2013

Related U.S. Application Data
(60) Provisional application No. 61/658,736, filed on Jun. 12, 2012.

(51) Int. Cl. G06Q 10/06

(52) U.S. Cl. CPC G06Q 10/063112
USPC 705/7.14

(57) ABSTRACT

The present disclosure relates to a recruiting management system that acts as a computer network portal for recruiters, or recruiting coordinators, such as college and professional scouts/recruiters/coaches to disseminate, analyze and critique information related to prospects (e.g., high school, collegiate and/or professional athletes). In some embodiments, the recruiting management system enables recruiters and prospects real-time, up-to-date and on-line access to information related to recruiting events and/or statistical data. The management system facilitates recruiters the ability to communicate, search, select and screen the entire pool of athletes in a particular sport, based on customized and flexible criteria. The management system further enables recruiters the ability to adjust, update and view information related to prospects tangible attributes, event participation and performances, among other analytics associated with prospects.

### CROSS REFERENCE TO RELATED APPLICATION

This application claims priority from U.S. Provisional Application Ser. No. 61/658,736, filed Jun. 12, 2012, entitled “Recruiting Management System,” which is incorporated herein by reference.

### COPYRIGHT NOTICE

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND

One of the main challenges faced by a coach of a sports team (e.g., college sports team) lies in the recruiting of athletes. For example, colleges typically recruit athletes from junior colleges and/or high schools. Each year, the pool of available athletes is large, and the time that coaches or his/her staff can devote to recruiting activities is limited. Some athletes are more talented than others, and a coach must try to recruit the most talented athletes that he/she can get in the short amount of time available to him based on a limited scope of information. The information can be limited to an athlete's profile or information gathered at sporting events or recruiting events where the athlete's showcase their abilities (e.g., a scouting combine).

The National Collegiate Athletic Association (NCAA) imposes recruiting process rules that in some manner inhibit a coach's ability to properly scout and accumulate all the proper and relevant information. Such rules make it difficult for a coach to establish a relationship with an athlete that the coach wants to recruit. Additionally, because statistics alone rarely tell the whole story, a coach usually will want to see an athlete in action before deciding whether to attempt to recruit that athlete.

### SUMMARY OF THE DISCLOSURE

The present disclosure addresses failings in the art by providing a system and method for managing recruiting and tournament information gathered during the process of scouting. The present disclosure discusses an athlete recruiting system that allows a recruiting entity, such as a coach, to search for and/or identify athletes that satisfy recruiting criteria. Indeed, the disclosed methods and systems provide coaches the ability to adjust, update and view information related to prospects tangible attributes, event participation and performances, among other analytics associated with prospects. The information provided to a coach is communicated to a coach in an automated manner, which enables the coach to annotate, adjust and/or personally denote information personally observed by the coach in real-time.

By way of background, from the perspective of both the recruiter (or coach) and the athlete, the current sports recruiting procedures suffer from several limitations. The required recruiting events necessarily place a geographical limitation on the entire process, restricting the pool of prospective athletes for particular teams and the choice of colleges for many high-school athletes. There is also a hierarchical limitation, smaller colleges with limited budgets and personnel are limited in the breadth of their search, and athletes from lesser known schools receive limited exposure to the recruiters. Additionally, the resources and tools provided to each coach at recruiting events are archaic and cumbersome to utilize.

The recruiting system disclosed herein improves a way recruiters and coaches of sports teams can view, critique, and evaluate athletes at events. Recruiters, coaches, and, in some embodiments, athletes using the recruiting system (or portal) will be able to research and evaluate prospective athletes. Recruiters and coaches will have the ability to view an athlete's information including, but not limited to, pertinent statistics, biography, academic standing as well as, tangible and intangible attributes. Additionally, recruiters/coaches will have the ability to update and annotate an athlete's information based on the events.

Additionally, using media streaming, recruiters/coaches will also be able to view associated video segments highlighting the athlete's participation in high school or college sports events in association with the event information accessed at said event. The recruiting system provides a portal that is also applicable to the transmission, storage and efficient access of information. Indeed, such information may also be accessible to the many different regulatory agencies involved in the governing of respective athletics.

In accordance with one or more embodiments, a method and system are provided for recruitment management. In accordance with one or more embodiments, a non-transitory computer-readable storage medium is provided, the computer-readable storage medium tangibly storing thereon, or having tangibly encoded thereon, computer readable instructions that when executed cause at least one processor to perform steps within the scope of the present disclosure related to recruitment management.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 depicts an example of a system architecture according to some embodiments of the present disclosure;

FIG. 2 depicts an example of a client device according to some embodiments of the present disclosure;

FIG. 3 depicts a flow diagram according to some embodiments of the present disclosure;

FIG. 4A-4E depict examples of embodiments displayed within a user interface of a computing device according to some embodiments of the present disclosure;

FIG. 5 depicts an example of an embodiment according to the present disclosure;

FIG. 6 depicts an embodiment displayed within a user interface of a computing device according to some embodiments of the present disclosure; and

FIG. 7 is a block diagram illustrating an architecture of a hardware device in accordance with one or more embodiments of the present disclosure.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

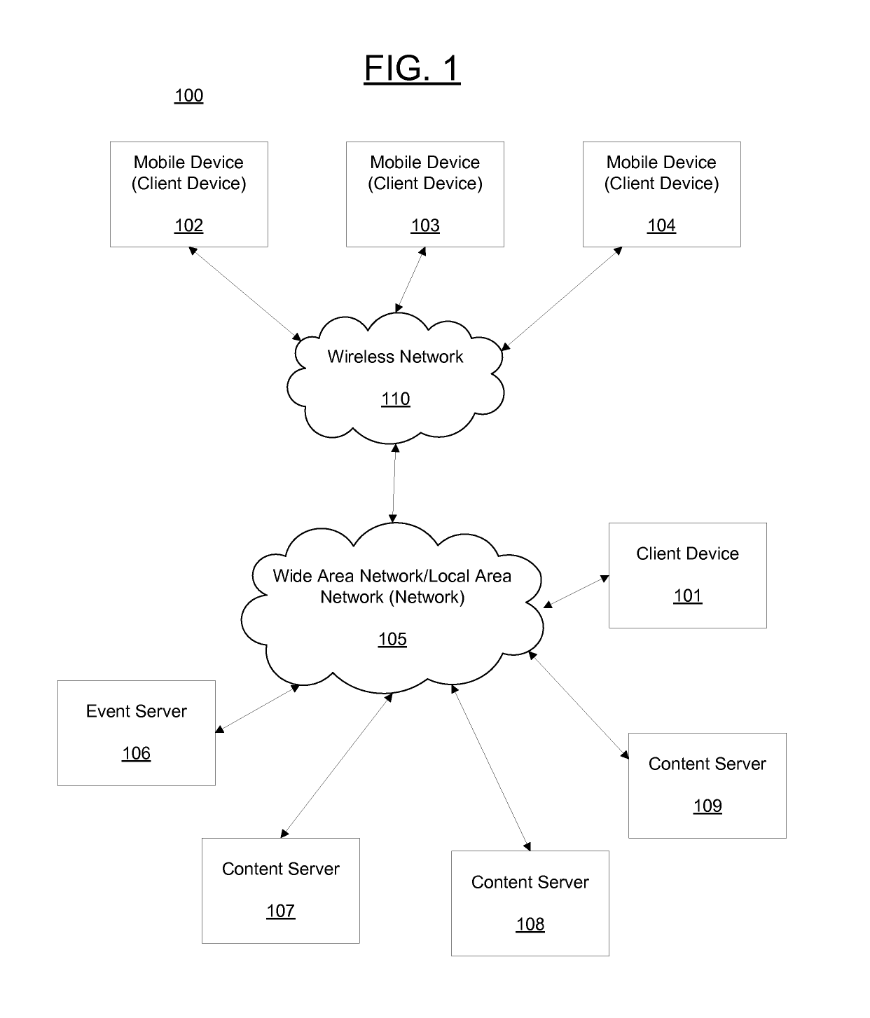

The preferred embodiments of the present disclosure will now be described with reference to FIGS. 1-7. FIG. 1 is a schematic diagram illustrating an example of an embodiment of a network. Other embodiments that may vary, for example, in terms of arrangement or in terms of type of components, are also intended to be included within claimed subject matter. As shown, FIG. 1, for example, includes a variety of networks, such as local area local area network (LAN)/wide area network (WAN) 105 and wireless network 110, a variety of devices, such as client device 101 and mobile device 102, and a variety of servers, such as content server 107 and event server 106. In connection with the illustrated example, which is non-exhaustive, additional or fewer servers may be utilized to transmit (and/or store data) between users, as will be understood from the below discussion.

For purposes of this disclosure, a “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server.

In conjunction with the depiction illustrated in FIG. 1, and discussed herein, servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

A content server may include a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VoIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire line type connections, wireless type connections, or any combination thereof. Likewise, sub networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Although there are various types of networks, wireless networks may be used. A wireless may couple client devices with a network. A wireless network may employ standalone ad hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Within the communications networks utilized or understood to be applicable to the present disclosure, such networks will employ various protocols that are used for communication over the network. Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

In some embodiments, the disclosed subject matter may comprise a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Accordingly, in some embodiments, the present disclosure may be utilized via a content distribution system comprising a peer-to-peer network. A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

According to some embodiments, the present disclosure may also be utilized within a social network. A social network refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. A social network may include individuals with similar experiences, opinions, education levels or backgrounds. Subgroups may exist or be created according to user profiles of individuals, for example, in which a subgroup member may belong to multiple subgroups. An individual may also have multiple associations within a social network, such as for family, college classmates, or co-workers.

An individual's (e.g., coach's or athlete's) social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

In some embodiments, multi-modal communications may occur between members of the social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, SMS/MMS, email, instant messenger clients, forums, social networking sites, or the like.

The above present persistent collaborative environment for interactive web applications provides persistence and sharing mechanisms for arbitrary application-defined objects. The sharing mechanism is coupled with a consistency mechanism that keeps client states consistent even when users perform conflicting operations. In addition, the framework maintains the interactivity of the web application at all times. The following sections provide descriptions of various embodiments of the present framework including the architecture, software and operations.

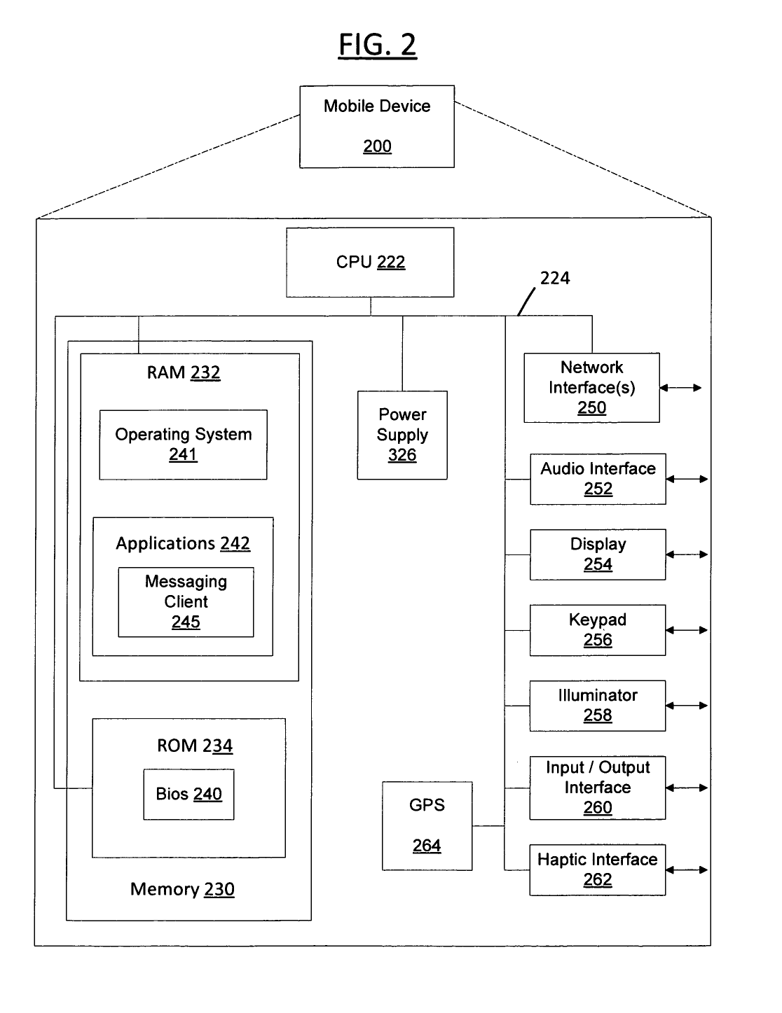

FIG. 2 shows an example embodiment of a client (or user) device that may be used. A client device 200 may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a web enabled Personal Digital Assistant (PDA), a handheld computer, a tablet computer, a laptop computer, a set top box, a wearable computer, a game console, smart TV, an integrated device combining various features, such as features of the forgoing devices, or the like. The user device (or client device) includes a processor and memory for storing and executing data and software. Computing devices may be provided with operating systems that allow the execution of software applications in order to manipulate data. A client device can be connected to the network, such as the Internet, via a wired data connection or wireless connection such as a Wi-Fi network, a satellite network or a cellular telephone network. A client device can support any type of interface for enabling the presentation or exchange of data. In addition, a user device may facilitate various input means for, but not limited to, receiving and generating information, including touch screen capability, keyboard and keypad data entry and voice-based input mechanisms. Any known and future implementations of user devices are applicable.

The client device 200 may vary in terms of capabilities or features. Subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

The client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, IMs, short message service (SMS), or multimedia message service (MMS), including via a network, such as a social network. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

A client device computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

By way of background, coaches main resource of information for recruiting are static and locally provided information sources. Generally, coaches can attend tournaments or other types of recruiting/scouting events to view prospects. As used herein, “prospects” refer to prospective athletes who coaches are scouting prospective of an athlete joining their team or being drafted by the coaches program or team.

Generally, tournament or recruiting event organizers, referred to as “organizers” can create event. Such organizers can include coaches, athletic directors for universities or colleges, scouts for professional or semi-professional teams, high school coaches, AAU organizers or coaches, legion organizers or coaches, or any other type of person or entity involved in organizing a tournament or scouting event. Some non-limiting types of “events” include, but are not limited to, tournaments, scouting events, regular and/or post season tournaments, combines, and the like. For ease of explanation, reference will be made to “events” but should be understood to include any types of recruiting events that afford a potential scout, coach or “organizer” the ability to gauge and/or review an athletes ability (including in person meetings with the athlete and his/her family). Additionally, for each of explanation, recruiters, scouts or coaches will be referred to as “coaches”, in that, according to some exemplary embodiments, within the realm of collegiate athletics, coaches will most frequently be attending such events held by organizers.

Currently, an organizer can organize or create an event (or tournament). The organizer, after organizing the event and sending out the necessary invitations to coaches and athletes, can create event data to that event. The event data file contains athlete and coach data, as discussed below. For example, the athlete data can include information related to each athlete's tangible and academic credentials. Coach data can comprise the program the coach is affiliated with, the program's ranking and affiliated division, the coach's record, and the coach's expressed needs (e.g., the positions or types of recruits the coach is interested in viewing).

Generally, upon a coach attending an event, the coach will be given a binder of information related to the athletes present. The binder is typically a physical file of information related to the events ongoing and/or the athlete's present. That is, the information in the binder is a physical realization of the event data. Alternatively, the binder can comprise an electronic file (e.g., CD, disk, flash drive and the like) which a coach can load onto their device or print out. Such information is compiled by the organizer of the event, a third party, and is then physically handed over to the coach. As such, the coach must make manual notes in association with the binder, then proceed to process such information at a later time, after the event. Additionally, in order for the coaches to obtain the binder of event data the coach must pay a standard fee, in addition to the attendance fee (in some cases).

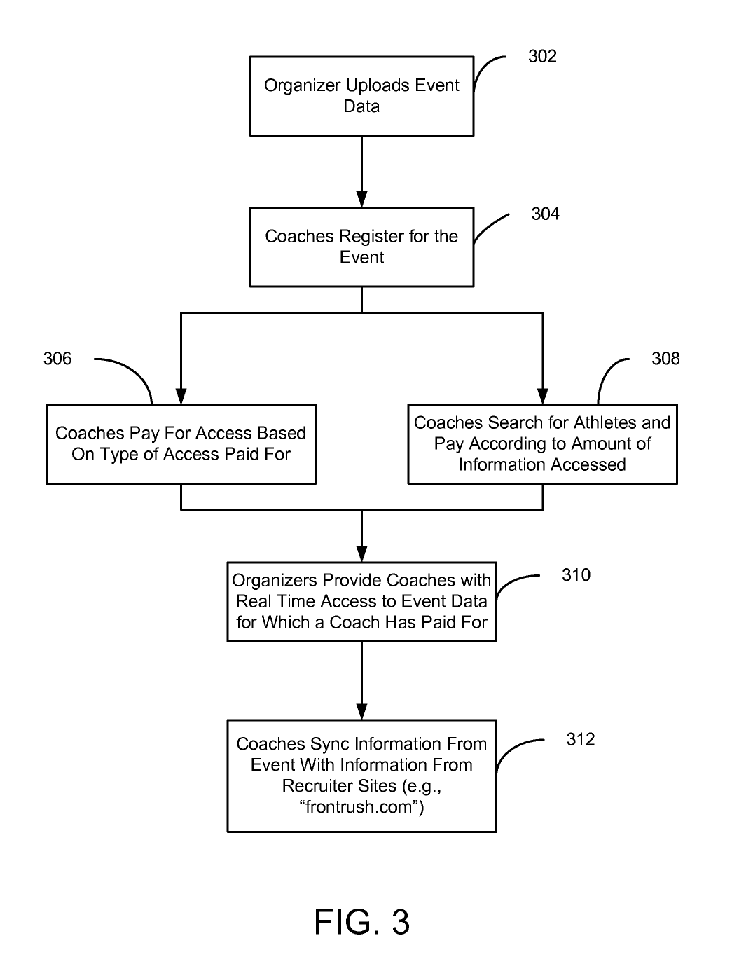

The present disclosure remedies the shortcomings present in the field of recruiting at events, as discussed in reference to FIG. 3. For example, after an organizer creates an event, the organizer can process the event data and store the data in a database which can be accessed locally or over a network. According to some exemplary embodiments, access to the event data is provided by a graphical user interface on a client's device via a downloadable application. The downloaded application, in accordance with the exemplary embodiments, renders a graphical user interface (GUI) which provides a user (e.g., coach, athlete or organizer) a visual display of event data, and the ability to access, view, render, modify, adjust, and/or update information, as discussed below and in relation to FIGS. 3-6. For example, the recruiting system, which is provided/implemented via a downloaded application, can be downloaded from an “app store”, e.g., an online resource that provides downloadable application for user devices, or from a hosting web site (e.g., frontrush.com or coachpacket.com). For example, users (coaches) can download or use over-the-air applications or widgets (which are processes or functionality which run within an application, such as a client or server application) from a variety of online application vendors. Other embodiments may exist where the GUI for the recruiting system is provided by a client device, web-based provider and/or operating system running on the client device or server computing device.

The event data, in a non-limiting example, can be stored in a the database(s) in the form of a CSV. In alternative embodiments, the data may be stored in an alternative format (e.g., XML, JSON, text, etc.) or maybe entered via a form (e.g., a web-based GUI). That is, the event data compiled by the organizer can be allocated according to a database of information associated with the attending athletes and coaches and uploaded to an event server, step 302. It should be understood by those of ordinary skill in the art that the information comprised within the event data can be in the form of any readable/writable data that is importable and exportable from a database to and from a server(s), third party site, and a user's device.

As discussed herein, the event data comprises information related to athletes. According to some embodiments, for each athlete, the event data includes specified types of information in a databases. Generally, the type of information stored is the kind of information that a recruiter or coach would be interested in knowing. For example, an athlete's information, some or all of which may comprise the athlete's profile, includes athletic performance information, athlete academic information, and athlete biographical information. Athlete performance information may include athletic statistical information and/or athletic performance video data. For example, an athlete's information may include the following types of information about the athlete: name, team position, home address, home telephone number, birth date, e-mail address, parent/guardian name, level (e.g., high school, junior college, etc.), school year (e.g., freshman, sophomore, junior, senior), years of NCAA eligibility, school name, school location (e.g., city and state), coach name, and coach telephone number. Furthermore, an athlete's information may include the following types of athlete academic information: grade point average and standardized test scores (e.g., ACT, SAT, PSAT, etc.). Additionally, an athlete's information may include the following types of athletic statistical information: height, weight, and sports-specific statistics (e.g., for basketball: points per game, rebounds per game, vertical jump height, field goal percentage, free throw percentage, 3-point field goal percentage, total assists, total steals, total blocks, etc.). An athlete's information also may include the following types of athlete biographical information: athletic achievements and awards, desired college qualities, intended major, desired sport program qualities, desired coach qualities, hobbies and activities, people who influence decisions (e.g., parents or guardians), and the like. According the some embodiments, the athlete themselves may provide the above information, or such information may be compiled over time during recruiting by a collection of coaches or a single coach or a collection of organizers or a single organizer, or any combination thereof.

According to some embodiments, the event data may also comprise schedule information for the respective event or for attendees of the event. That is, for example, the event data may include information comprising, but not limited to, check-in/out times/dates for athletes and coaches, the schedule of games/activities taking place during the event, updated scores/results from such games/events, and/or any other type of data that can be compiled and communicated from such an event. In some embodiments, the event data, via the recruiting system, can indicate where or when during an event a coach or athlete is located. That is, the event data can provide a coach's or athlete's location within event and/or schedule for the event. The location of a coach/athlete can be visually displayed within the recruiting system's GUI on a map of the event. For example, Coach X is attempting to locate Athlete Y. Coach X identifies, via Athlete Y's event data (e.g., schedule information) that Athlete Y is playing on field 2 at the event at 11:00 am on Jun. 20, 2012. Coach X can also be presented with a layout/map of the event complex/facilities. The layout map can be provided on the GUI or within a portion of the GUI. On the map, an indicator providing Athlete Y's location can be depicted. The indicator can be annotated/or accompanied with appended or linked data providing the information or additional event data regarding Athlete Y. That is, the indicator may be clickable/selectable on the map, which can provide additional information about Athlete Y, for example, additional event data regarding the athlete's biography.

The event data, according to some exemplary embodiments of the recruiting system discussed herein, can employ different encryption strengths and/or algorithms. In order to monetize this, organizers and/or content providers can structure different pricing/fees in accordance with encryption strength. For example, athlete, coach or program/event/organization-specific data, even when encrypted, can be stored in a separate directory from that of other athletes, coaches, or programs/events/organizations and/or users. In some embodiments, government rules and/or regulations can require different characteristics of encrypted data. The encryption can be a standard 256 bit AES (Advanced Encryption Standard) algorithm, approved by the NIST (National Institute of Standards and Technology), and uses both Symmetric and Asymmetric encryption/decryption keys. Thus, the communications associated with the recruiting system can be encrypted as well as any attachments or metadata (annotations, images, videos) associated with such communications.

Upon an event's occurrence, the organizer can upload the event data as a file (a CSV as discussed above) to a central event server. Coaches, after registering with the event and receiving a user ID, can access the event data, step 304. That is, according to some embodiments, coaches upon attending an event and/or in order to access said information will have register with the organizer or event. The coach can designate a specific identifier (e.g., the coach's email address) or be given an event specific identifier.

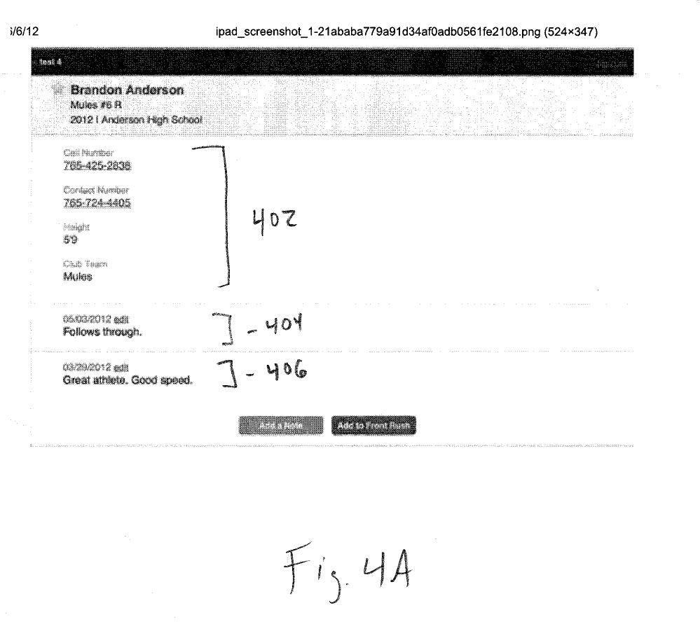

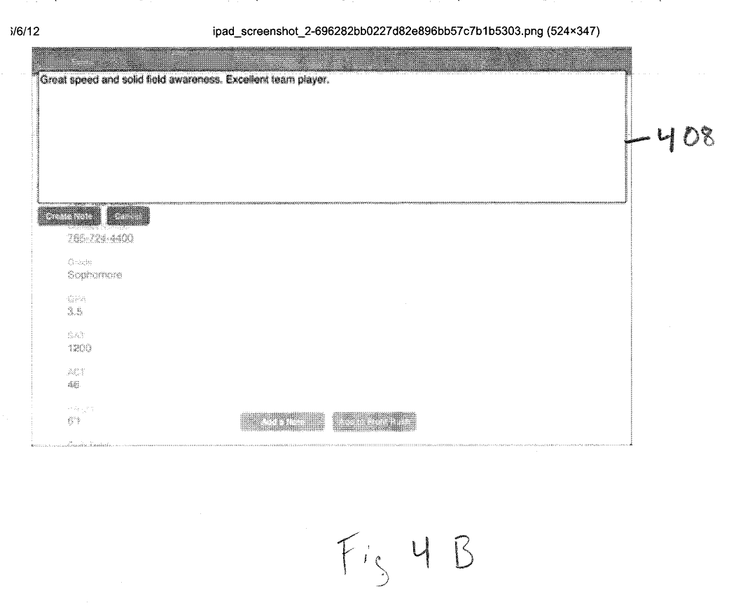

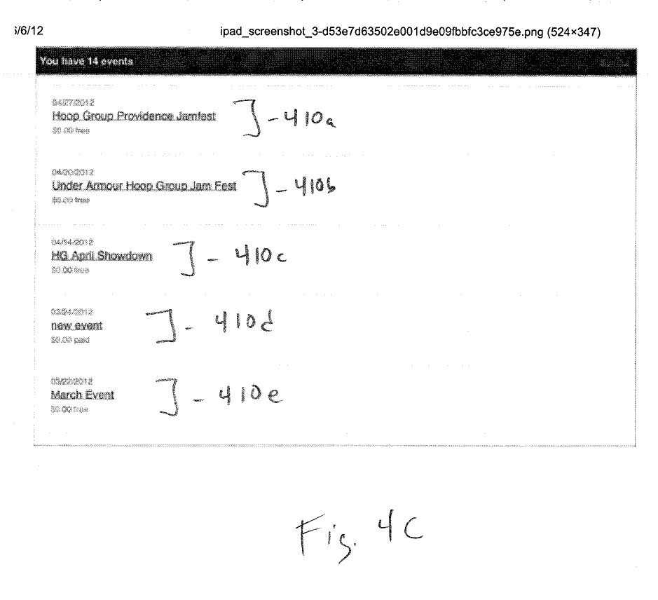

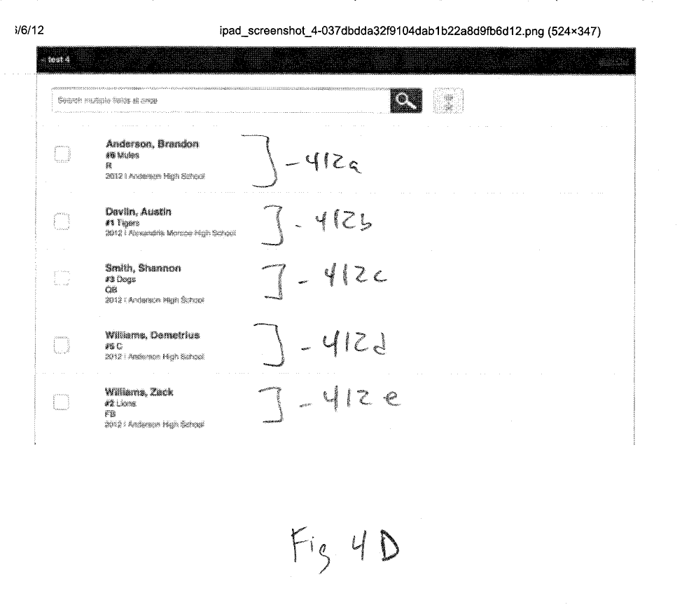

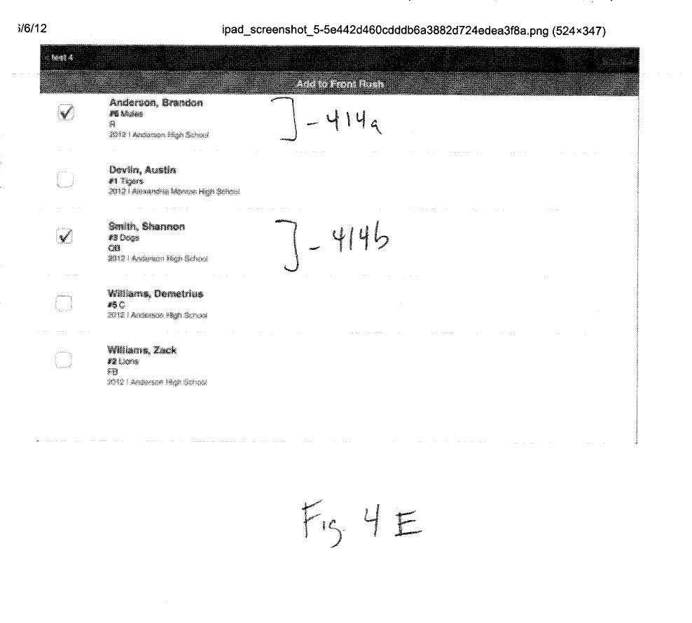

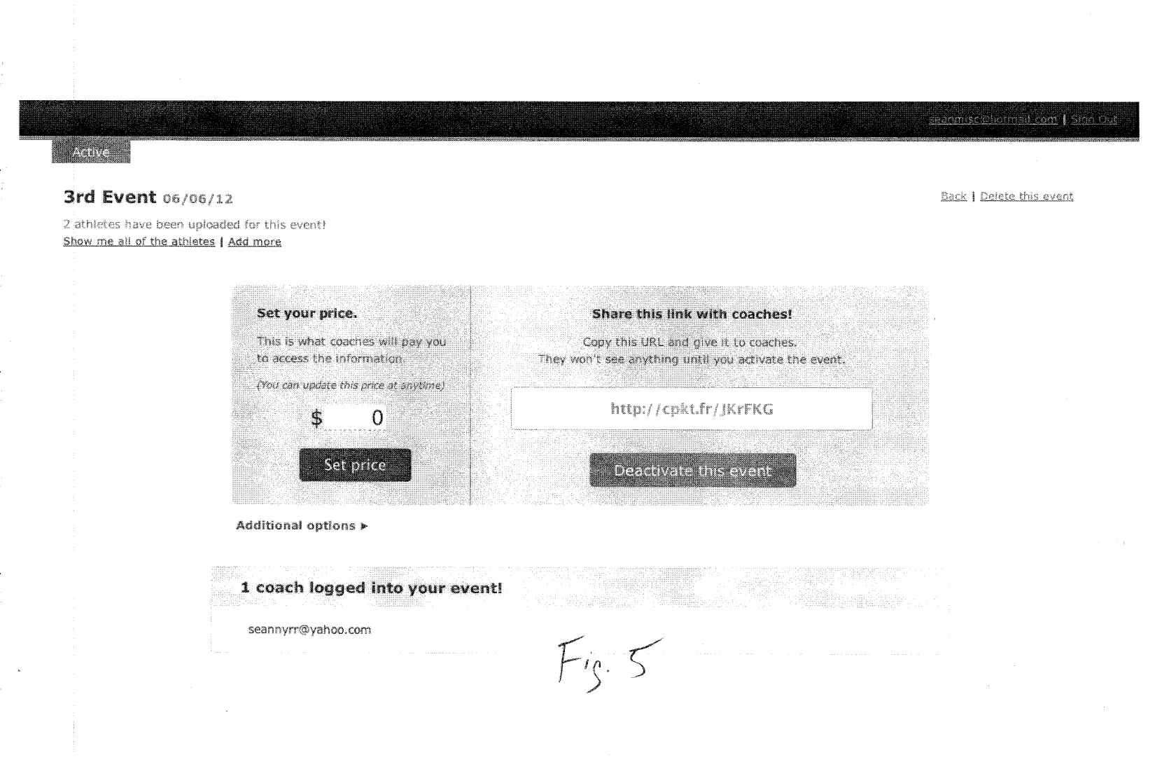

Access to the event data can be based on the type and amount of information the coach desires. The event data can be accessed by the organizer denoting a specific network location to retrieve the event data. Alternatively, the organizer can distribute or alert attending coaches to a URL for which access to event data is given. In some embodiments, access to the event data can be based upon a coach's identifier and/or a tournament limit. That is, according to some exemplary embodiments, access to the event data is predicated upon a requesting coach paying an access fee, as seen in FIG. 5. Further, as illustrated in FIGS. 4A-E, the event data can be displayed in on a graphical user interface (GUI) on a coach's device. In some embodiments, the display occurs within a browser running on the coach's device.

For example, a coach can pay a certain amount for a single athlete's information, and/or a certain amount for a “bucket” (or plurality) of athletes. See FIG. 5. For example, Coach A attends Event B and desires to download information related to Athletes X, Y and Z. As such, the organizer can charge the coach $0.99 per athlete, or a predetermined price for a “bucket”. That is, since there are 3 athletes listed in the coaches request, the coach can pay $2.50 for the bucket; a discounted rate due to the bucket.

Accordingly, as discussed above, the coach can be given access to each athletes' information, steps. 306 and 308. See also FIG. 4A. Access can be granted according to a centralized network location where access to each athletes' information is based upon the coach's identifier (e.g., username, email address, or personalized ID per event). That is, upon accessing the event, based on the coach's ID, the coach will only be afforded the information for which he/she has paid, step. 306. In some embodiments, based on the information purchased by the coach, the organizer can provide the coach with a customized URL for which only the purchased or accessible information is present.

According to some embodiments, the recruiting system can provide and display a listing of athletes that satisfy user-specified criteria, step 308. For example, a coach can search for event data according to specified terms. This involves an input mechanism through which a user can input specified criteria. For example, the input mechanism may be an HTML form accessible via the recruiting system that includes multiple input fields. Each input field corresponds to an item of information that the athlete recruiting system stores in association with an athlete. For example, one input field may correspond to a “height” information item, and another input field may correspond to a “weight” information item. One or more input fields may correspond to sport-specific information. For example, an input field may correspond to a “vertical jump height” information item. Multiple input fields may correspond to a single information item. For example, both a “maximum height” input field and a “minimum height” input field may correspond to a single “height” information item.

Accordingly, the HTML form includes a mechanism, such as a graphical button, that, when activated, causes a browser to send the contents of the input fields to an event server. In response to receiving the contents of the input fields, the event server generates and sends a database query to a database server. The database query instructs the database server to select, from a database, the identities of all of the athletes that satisfy the criteria specified in the input fields. The database query may also instruct the database server to select additional information from the available event data about the athletes that satisfy the criteria. In response to receiving the database query, the database server selects, from a database, the identities of all of the athletes that satisfy the criteria specified in the input fields. For example, if the criteria specify only a minimum height of 6′1″, then the database server selects all athletes associated with a height of at least 6′1″. Depending on the database query, the database server also may select, from the event data available on the database associated with the event server, additional information about the athletes that satisfy the criteria. The database server returns the selected information to the event server, which dynamically generates a web page that contains the selected information. The web server sends the dynamically generated web page to the browser from which the HTML form was submitted. The browser receives the web page and presents the web page to the coach that specified the criteria. Accordingly, access to such requested data can be predicated upon paying a fee for such data, either before searching or after performing said search.

In one embodiment, the selected information includes the names of the athletes whose athlete information satisfies the specified criteria. Each such name may be presented in a separate link to a profile page for the corresponding athlete. See FIG. 4D. The links that indicate names of athletes whose profiles a recruiter or coach has already requested may be visibly distinguished from the links that indicate names of athletes whose profiles the recruiter has not already requested. For example, a browser may display, in a different color, links to pages that have already been visited. When generating the web page that lists the selected athlete names, an event server may use these associations to determine the manner in which the names of various athletes should be displayed, to distinguish athletes whose profiles have been requested in one or more of a particular organization's sessions from the names of athletes whose profiles have not been requested in any of the particular coaches sessions. According to one embodiment, the event server does not rank the selected information when generating the web page. This allows a recruiter to make his own judgments about the desirability of each athlete without being influenced by factors that might not be relevant to the recruiter.

According to some embodiments, the recruiting system enables the coach to view the selected information and save and/or later restored said event data. For example, the web page indicating the results may contain a “save” control that, when activated, causes the information contained in the web page to be associated with a coach's session. Alternatively, the activation of the “save” control may cause the information contained in the web page to be stored in a file on the client device on which the browser displaying the web page resides.

According to some embodiments, the recruiting system can enable users, such as coaches, organizers and/or athletes, to recognize other users using a augmented reality, virtual reality, and/or facial recognition, or a combination thereof, to immediately access event data. Augmented reality (AR), or mediated reality, is a live, direct or indirect, view of physical, real-world environment whose elements are augmented via computer-generated sensory input such as sound, video, images, graphics or GPS (location) data. The augmentation is typically in real-time and in semantic context with environmental elements, such as the event data, or athletes/coaches during the event. Thus, information related to an event, coach and/or athlete, e.g., event data, becomes interactive and provides a digitally manipulability environment. In some embodiments, event data can be overlaid on the GUI to provide a user with the full wealth of information available at an event and provided by the recruiting system discussed herein.

For example, while a coach is attending an event and watching a game, a coach can be afforded the ability to point his device (e.g., mobile device) at an athlete and retrieve all the event data related to such athlete. That is, a coach can, for example, open the optics or infrared input/output of his/her device (e.g., image capture via a digital camera) and identify the identity of an athlete. As discussed above, the retrieved event data can be augmented on the coach's GUI. This enables the coach the ability to view information about the athlete on his/her device while watching the athlete. Augmentation can occur when a coach is viewing a video, image or other information of an athlete, and such information can be augmented with additional event data based on the image capture.

By way of another non-limiting example, Coach X is watching a football game at an event and Athlete Y scores a touchdown. Coach X may want to identify the athlete and retrieve Athlete Y's information (or event data). Instead of searching the recruiting system, as discussed above, Coach X can point his/her device at Athlete Y and via facial recognition, Athlete Y's event data will be retrieved and visually displayed on Coach X's device. In some embodiments, the recognition of Athlete Y can be facial recognition. This can be predicated upon Athlete Y's event data including Athlete Y's picture/image, from which the image scanning of Athlete Y at the game can be compared against the images stored in the recruiting system database. It should be understood that recognition of an athlete should not be limited to facial recognition, in that an athlete or individual can be recognized based upon any traits which are recognizable from image capturing, or other known or to be know recognition/capturing techniques/functionality. In some embodiments, the scanning and retrieval of athlete data based on AR and/or recognition can be based upon proximity location and/or other information detection methods either known or to be known. In another example, the image capture of Athlete Y by Coach X can identify that Athlete Y is wearing a jersey with number 10 written on it. Based on the identification that number 10 has been identified in accordance with the location information derived from the image capture (e.g., one player wearing number 10 at field 2), or Coach X's location data (e.g., Coach X located at field 2), or the event data associated with an athlete wearing number 10 on a particular field (or location at the event—schedule information included within the event data), Athlete Y's data can be retrieved and displayed. Alternative embodiments also exist where event data can be retrieved based upon a scanned bar code (or other identifiable optical machine-readable representation of data) that may be worn on the athlete's jersey or within the proximity of the athlete (or location within/at the event).

Additionally, as discussed above, coaches can access the event data by logging into an event via a specific identifier (e.g., the coach's email address) or be given an event specific identifier. Embodiments also exist where a coach can login to the event via facial recognition technology provided by the recruiting system, in that, upon the coach's image scan, the coach can be given access to the event data. In some embodiments, upon logging in, the coach can be displayed information related to event data regarding the event and/or athletes the coach has been scouting or viewing at the event, or in past events.

In some embodiments, the recruiting system also allows athletes to search for organizations based on athlete-submitted criteria. Coaches may submit program (e.g., university/college) information to the recruiting system in the same manner that athlete information is compiled. The recruiting system may present an athlete with a list of programs or coaches that are associated with information that satisfies the athlete's criteria. Such criteria may include, for example, region, division, student body size, win-loss statistics, etc.

As such, the coaches no longer need the physical binder of information. The information is accessible via the coaches device, e.g., tablet, smartphone and the like. That is, after registering with the event, receiving their ID (if needed) and paying for access to athlete information, coaches can immediately access event data based on the payment and authorization of the coach's ID. Indeed, this provides the coach with the ability view real-time information as the organizer can update the information about an event, in that, upon an update (e.g., an athlete's jersey number change), such updated data is immediately accessible to the viewing coach, step 310.

Additionally, in some embodiments, the recruiting system enables coaches, organizers and/or athletes (recruits) to communicate with each over via the recruiting system. That is, the recruiting system enables a coach, organizer or athlete to communicate with another respective user of the system via email, SMS, MMS, telephone, instant message, or via a social networking platform, such as, FACEBOOK®, TWITTER®, GOOGLE+®, and other known or to be known social and/or communication platforms. For example, after searching for an identifying an athlete that meets a coach's search criteria, or locating an athlete's event or biographical data within the recruiting system, the coach is afforded the functionality to communicate with the athlete via the recruiting system. Accordingly, the recruiting system enables such communication as discussed above, in that functionality for such communications are built in to the recruiting system's functionality (e.g., a widget, extension, ACTIVE X, or any other known or to be known enabling protocol).

Indeed, in some embodiments, the recruiting system may only enable such communication in compliance with NCAA rules and regulations. That is, during a time period where a coach is allowed to contact a recruit, the recruiting system well allow such communications. However, should the coach attempt to communicate with an athlete during a restricted period as set by the NCAA, such communication will be denied. In such a situation, the coach will be alerted to the denial of contact with the athlete and in some embodiments, the coach can also be alerted the reasoning of such denial. That is, the recruiting system can provide the coach an alert that the communication is denied and provide the coach with information related to the NCAA rule governing such denial (in addition to a link to the supporting rules/regulations). In some embodiments, the NCAA can also be alerted to the attempted rule violation. Embodiments also exist involving the same as discussed above related to an athlete or organizer attempted to communicate with a coach.

In some embodiments, as discussed herein, coaches can view the event data over a private network for the event or over a public network, e.g., the Internet. As such, the coaches will be afforded the ability to sync the event data they have accessed at the event with their other sources of information, step 312. For example, a coach can annotate and make other notations about event data accessed at an event during the event (e.g., commenting on how an athlete is performing). See FIGS. 4A and 4B. Additionally, the coach can immediately sync said information with their account associated with their current recruiting software (e.g., applications provided by FrontRush™ at frontrush.com). In some embodiments, the recruiting system can allow events or organizers of events to market or advertise their events through a hosting site, e.g., frontrush.com or coachpacket.com. This enables coaches and athletes to search for and/or identify upcoming events. Also, the recruiting system can enable the coaches and athletes to indicate that they are attending the event, whereby such information can be communicated to the event organizer (or hosting entity). Additionally, in some embodiments, event data from previous events can be synchronized with event data at current events so that a coach, athlete and/or organizer is able to access and utilize an aggregate of information collected from a plurality of users using the recruiting system (from current or past events, or other platforms/resources where event type data can be collected).

As such, the event data accessed by a coach can be stored in a “cloud” (which can be provided by the recruiting software provider (e.g., FrontRush™) or organizer). As used herein, a “cloud” is used in an art-recognized manner and can refer to a collection of centrally managed resources such as networked hardware and/or software systems and combinations thereof provided and maintained by an entity, wherein the collection of resources can be accessed by a user via wired or wireless access to a network that may be public or private, such as, for example, a global network such as the Internet. Such centralized management and provisioning of resources can provide for dynamic and on-demand provisioning of computing and/or storage to match the needs of a particular application. The cloud may include a plurality of servers, general or special purpose computers, as well as other hardware such as storage devices. The resources can include data storage services, word processing services, payment remitting services, and many other information technological services that are conventionally associated with personal computers or local and remote servers. Moreover, in one aspect, the resources can be maintained within any number of distributed servers and/or devices as discussed in more detail below. Thus, the present disclosure discusses a system that performs data management operations, including content-indexing and policy driven storage, within a cloud computing environment in order for a user to manage his/her personal information from a central online location.

As discussed herein, the recruiting system can be a cloud-based data repository that functions as a secure off-site repository/data storage that, in some embodiments, synchronizes event data with other real-time or updated event data that can be accessed by a coach. Additionally, the event data can be synchronized with other information accessible to the coach (e.g., recruiting information associated with the coach on a recruiting site: FrontRush™ applications). Security for the recruiting system can be facilitated through the use of known cryptographic techniques, such as for example, symmetric and/or asymmetric cryptographic keying technology.

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

For web portals, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases or site visits, for example. An identified correlation may be used to target potential purchasers by targeting content or advertisements to particular users. Yet another approach to ad targeting could be based upon a user's current activity. Tracking of a user's path, or current location within a web site, or network of sites, and compiling of information associated with the user and/or the user's activity, or location. For example, regarding a user's activity, besides tracking which sites a user is viewing, information related to a user's activity within a site, e.g., their conversations with other users via the provided IM, provide advertisers with real-time topic points that warrant productive pivot points to provide real-time and relevant ads.

An “ad server” comprises a server that stores online advertisements for presentation to users. “Ad serving” refers to methods used to place online advertisements on websites, in applications, or other places where users are more likely to see them, such as during an online session or during computing platform use, for example.

During presentation of advertisements, a presentation system may collect descriptive content about types of content presented to users or the content being provided by the users on particular sites or via their interaction within a site/domain or network. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Alternatively, the system may employ advertising techniques allowing individual advertisers to target users logging into a given session (or tournament) or accessing data from a provided resource or related to a single or plurality of athletes. In this embodiment, the system will allow an advertiser to monitor a coaches activity related to the information accessed or the location of such access. Also, such activity can be related to the type of information input or realized by each coach or user, or other users at the same event. In some embodiments advertisements may simply appear as a textual display optionally containing a hyperlink or other textual indicator. Alternatively, the advertisements may contain audio, video, or pictorial representations. In another embodiment, the system may allow advertisers to perform bulk analysis on past activity allowing for analytical analysis of the topics of discussion as a function of time. In another embodiment, advertisers may create interactive “bots” that interact with users (or coaches or prospects accessing the system) in manners other than simply broadcasting advertisements. In this example, an advertiser may utilize a bot that can simulate a discussion with the goal of advertising a particular event, service, product and/or assisting users in operating the website or webpage (e.g., coachpacket.com or other website hosting an event), as discussed in below.

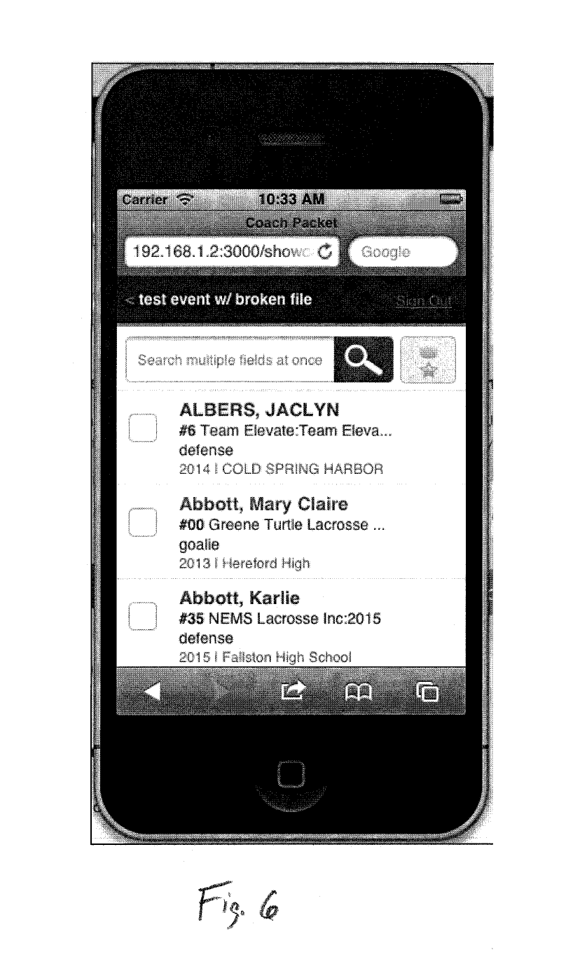

FIGS. 4A-4E depict non-limiting examples of embodiments of a user interface within the scope of the present disclosure. A browser executing on a client device displays a browser executable document (in some non-limiting examples a web page served from a website of a community provider system). The URL corresponding to the displayed web page is displayed by browser. As illustrated in FIG. 4A, a browser executable document is displayed to a coach on the coach's user device. In a non-limiting example according to FIG. 4A, an athlete's event data 402 is displayed to the coach on the coach's device. As discussed above, the coach can provide annotations 404 and 406 based on observations, which can be made based upon the athlete's performance at an event. As illustrated in FIG. 4B, the coach can add annotations 408 or comments about the athlete. As illustrated in FIG. 4C, the coach can access event data for past events 410c, 410d, 410e the coach has attended. In some embodiments, upon payment of permission, the coach can access future event data 410a, 410b prior to events. As illustrated in FIG. 4D, the coach can access and view event data for a plurality of athletes 412a-e, as discussed above. Accordingly, as illustrated in FIG. 4E, the coach can select particular athletes from the listing in FIG. 4D, and perform the steps illustrated in FIGS. 4A-4B, as discussed above. Accordingly, the depictions in FIGS. 4A-4E, in addition to the discussion above, can be performed on a mobile device, as illustrated in FIG. 6.

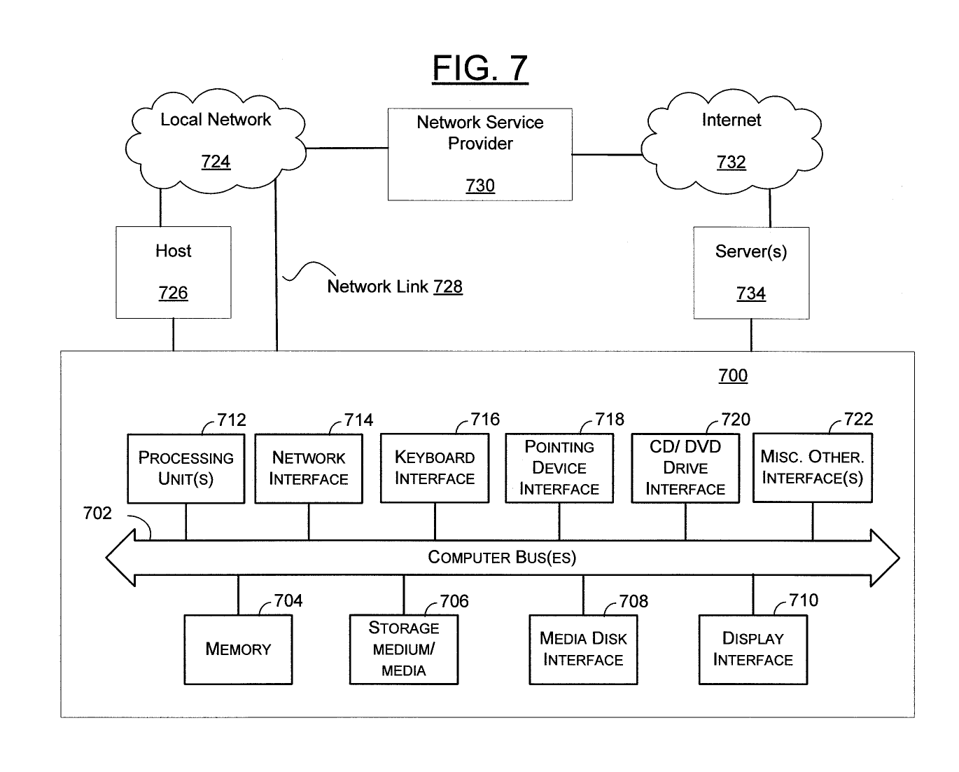

FIG. 7 is a block diagram illustrating an internal architecture of a computing device, e.g., a computing device such as server or user computing device, in accordance with one or more embodiments of the present disclosure. FIG. 7 illustrates a computer system upon which some exemplary embodiments of the present disclosure may be implemented. Although computer system 700 is depicted with respect to a particular device or equipment, it is contemplated that other devices or equipment (e.g., network elements, servers, processors) within can deploy the illustrated hardware and components of system 700.

As shown in FIG. 7, internal architecture 700 includes one or more processing units, processors, or processing cores, (also referred to herein as CPUs) 712, which interface with at least one computer bus 702. Also interfacing with computer bus 702 are computer-readable medium, or media, 706, network interface 714, memory 704, e.g., random access memory (RAM), run-time transient memory, read only memory (ROM), media disk drive interface 720 as an interface for a drive that can read and/or write to media including removable media such as floppy, CD-ROM, DVD, media, display interface 710 as interface for a monitor or other display device, keyboard interface 716 as interface for a keyboard, pointing device interface 718 as an interface for a mouse or other pointing device, and miscellaneous other interfaces not shown individually, such as parallel and serial port interfaces and a universal serial bus (USB) interface.

Memory 704 interfaces with computer bus 702 so as to provide information stored in memory 704 to CPU 712 during execution of software programs such as an operating system, application programs, device drivers, and software modules that comprise program code, and/or computer-executable process steps, incorporating functionality described herein, e.g., one or more of process flows described herein. CPU 712 first loads computer-executable process steps from storage, e.g., memory 704, computer-readable storage medium/media 706, removable media drive, and/or other storage device. CPU 712 can then execute the stored process steps in order to execute the loaded computer-executable process steps. Stored data, e.g., data stored by a storage device, can be accessed by CPU 712 during the execution of computer-executable process steps.

Persistent storage, e.g., medium/media 706, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 728 typically provides information communication using transmission media through one or more networks to other devices that use or process the information. For example, network link 728 may provide a connection through local network 724 to a host computer 726 or to equipment operated by an Network or Internet Service Provider (ISP) 730. ISP equipment in turn provides data communication services through the public, world-wide packet-switching communication network of networks now commonly referred to as the Internet 732.

A computer called a server host 734 connected to the Internet 732 hosts a process that provides a service in response to information received over the Internet 732. For example, server host 734 hosts a process that provides information representing video data for presentation at display 710. It is contemplated that the components of system 700 can be deployed in various configurations within other computer systems, e.g., host and server.

At least some embodiments of the present disclosure are related to the use of computer system 700 for implementing some or all of the techniques described herein. According to one embodiment, those techniques are performed by computer system 700 in response to processing unit 712 executing one or more sequences of one or more processor instructions contained in memory 704. Such instructions, also called computer instructions, software and program code, may be read into memory 704 from another computer-readable medium 706 such as storage device or network link. Execution of the sequences of instructions contained in memory 704 causes processing unit 712 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 700. Computer system 700 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 702 as it is received, or may be stored in memory 704 or in storage device or other non-volatile storage for later execution, or both.

### Other Embodiments

In addition to the discussion above, the present disclosure embodies the following embodiments and functionality, as referenced from Appendix A of the instant application. According to some embodiments, tournament/recruiting event organizers can create an event and upload data (csv) to that event. This file contains athletes and athlete data. When they upload the file, they either pay us $0.99 an athlete or buy bucket i.e. x number of athletes in the file puts them in a specific bucket. Once the data is uploaded organizers or affiliates (third parties) can set a price (to charge coaches), choose whether coaches can export the data to csv, and/or limit which coaches can have access to the event (like a ‘guest list’). The event organizer is given a URL (or custom URL of our own) which they then distribute to coaches. The coaches can access this URL from their mobile device or from their laptop. If the tournament director charges the coaches, then the coaches can pay via credit card (or PayPal®) and the money transfers directly to the tournament organizer. The tournament director can also update data in real-time (e.g. an athlete's jersey number changes).

At this point the coaches need online access to interact with the data but in the next few weeks, they will also have offline access. The coaches interaction includes searching for athletes, ranking athletes, and making notes on them. If they are also a Front Rush user, they can click ‘add to front rush’ and the data will transfer from their coach packet event to their Front Rush account. Any notes that were created on the recruit will show up in Front Rush as an “evaluation” as per NCAA requirements. The addition to Front Rush API is SOAP based or other known or to be known platform. Once the data is in Front Rush (e.g., existing or to be existing systems implemented, licensed, utilized or developed by FrontRush), it is used the same way any data in Front Rush is utilized. It also can be transferred to and from the schools respective admissions SIS (student information system).

Additionally, the recruiting system provides additionally functionality, in accordance with some embodiments in accordance with the above disclosure: 1) Giving athletes the ability to login so they can keep their data current as well as pay to provide additional data that the coach will be able to see e.g. images, videos, Social data, other tournaments attended/attending. 2) Giving athletes the ability to take that login to other sites e.g. they use their “Coach Packet” login to fill out a recruit questionnaire that exists on a current schools site. 3) Giving athletes the ability to register and Pay for Coach Packet events with their login. Also, giving tournament directors the ability to manage the registration process. 4) Giving the athletes mobile access so they can update their events/data/and the like from the event. 5) Coach packet can be implemented, used as an extension of, and/or incorporated into the FrontRush™ or other recruiting tools or applications. 6) Native mobile versions of the recruiting system.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “prospect”, “coach”, “student”, “athlete”, “subscriber” or “customer” should be understood to refer to a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

The disclosure described herein for recruiting athletes is applicable to a variety of contexts and implementations and is not limited to a particular context or implementation. For example, as used herein, organizations include recruiting entities such as colleges, universities, professional sports teams, semi-professional sports teams, apparel companies, scouting groups, marketing companies, sports agents groups, etc. Although approaches described herein are applicable to schools, approaches described herein are equally applicable to recruiting entities other than schools. Recruiting entities include entities that recruit athletes, but approaches described herein may be used to recruit individuals other than athletes. For example, approaches described herein may be used by business organizations to recruit employees.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method for managing recruiting and tournament information, the method comprising:
storing, via a computing device, event data for a one or more events;
defining, via the computing device, a plurality of access methods, wherein the plurality of access methods is defined by an event organizer;
receiving, at the computing device, an access request for the event data from a user in accordance with one of the defined access methods;
validating, via the computing device, the access request; and
providing, via the computing device, an allowed subset of the event data to the user.

2. The method of claim 1 wherein the event data comprises athlete data and coach data.

3. The method of claim 2 wherein athlete data comprises one or more of athletic performance information, academic information, or biographical information.

4. The method of claim 2 wherein the coach data comprises one of a program a coach is affiliated with, the program's ranking and affiliated division, the coach's record, and the coach's expressed needs.

5. The method of claim 1 wherein the event data comprises scheduling information for events.

6. The method of claim 1 wherein storing event data further comprises receiving a data file from the event organizer.

7. The method of claim 2 wherein defining a plurality of access methods comprises allowing access to a predefined number of athletes associated with the athlete data.

8. The method of claim 1 wherein receiving an access request for the event data further comprises receiving an image of an athlete.

9. The method of claim 1 further comprising exporting the allowed subset of the event data to a recruiting software provider.

10. The method of claim 1 wherein providing an allowed subset of the event data to the user further comprises providing one or more advertisements in conjunction with the allowed subset of event data.

11. A non-transitory computer-readable storage medium tangibly encoded with computer-executable instructions, that when executed by a processor associated with a computing device, performs a method comprising:
storing event data for a one or more events;
defining a plurality of access methods, wherein the plurality of access methods is defined by an event organizer;
receiving an access request for the event data from a user in accordance with one of the defined access methods;
validating the access request; and
providing an allowed subset of the event data to the user.

12. The non-transitory computer-readable storage medium of claim 11 wherein the event data comprises athlete data and coach data, wherein athlete data comprises one or more of athletic performance information, academic information, or biographical information, and wherein the coach data comprises one of a program a coach is affiliated with, the program's ranking and affiliated division, the coach's record, and the coach's expressed needs.

13. The non-transitory computer-readable storage medium of claim 11 wherein the event data comprises scheduling information for events.

14. The non-transitory computer-readable storage medium of claim 11 wherein storing event data further comprises receiving a data file from the event organizer.

15. The non-transitory computer-readable storage medium of claim 12 wherein defining a plurality of access methods comprises allowing access to a predefined number of athletes associated with the athlete data.

16. The non-transitory computer-readable storage medium of claim 11 wherein receiving an access request for the event data further comprises receiving an image of an athlete.

17. The non-transitory computer-readable storage medium of claim 11 further comprising exporting the allowed subset of the event data to a recruiting software provider.

18. The non-transitory computer-readable storage medium of claim 11 wherein providing an allowed subset of the event data to the user further comprises providing one or more advertisements in conjunction with the allowed subset of event data.

19. A system comprising:
at least one computing device comprising:
memory storing computer-executable instructions; and
one or more processors for executing said computer-executable instructions, comprising:
storing event data for a one or more events;
defining a plurality of access methods, wherein the plurality of access methods is defined by an event organizer;
receiving an access request for the event data from a user in accordance with one of the defined access methods;
validating the access request; and
providing an allowed subset of the event data to the user.

20. The system of claim 19, further comprising:
exporting the allowed subset of the event data to a recruiting software provider.
